(19) United States
(12) Patent Application Publication
(10) Pub. No.: US 2016/0143226 A1
(43) Pub. Date: May 26, 2016

(54) HYDRAULIC CONTROL SYSTEM FOR USE WITH A TURF SWEEPER

(71) Applicant: BROCE MANUFACTURING CO., INC., Dodge City, KS (US)

(72) Inventor: Mark A. McCart, Norman, OK (US)

(21) Appl. No.: 14/899,869

(22) PCT Filed: Jul. 1, 2014
(86) PCT No.: PCT/US14/45123

§ 371 Date: Dec. 18, 2015

Related U.S. Application Data
(60) Provisional application No. 61/842,155, filed on Jul. 2, 2013.

(51) Int. Cl. A01G 1/12

(52) U.S. Cl. CPC A01G 1/125

(57) ABSTRACT

A turf sweeper with a rotatable brush including an adaptable hydraulic control system is disclosed. The turf sweeper includes a controller adapted to modify the hydraulic system to affect the rotational speed and direction of the rotatable brush. The controller and hydraulic control system are adapted such that the rotatable brush will not rotate if the turf sweeper is turned on and the speed adjuster for the rotatable brush is not set to the zero speed setting.

### CROSS-REFERENCE TO RELATED APPLICATION

This application claims the benefit of U.S. Provisional Application No. 61/842,155 filed Jul. 2, 2013, which is hereby incorporated by reference.

### FIELD OF THE INVENTION

The present process and system relate to turf sweepers and, more specifically, to turf sweepers using hydraulic control systems.

### BACKGROUND OF THE INVENTION

Turf sweepers are typically used to collect debris on turf. Turf sweepers may be towed or self propelled and operate by contacting turf with a rotatable brush. The brush bristles of the rotatable brush contact the turf and cause foreign matter to separate from the turf. The rotatable brush in the turf sweeper can be powered by a hydraulic system.

Previous hydraulically powered turf sweepers lacked appropriate safety and control systems. More specifically, previous turf sweepers lacked component safety controls that prevent sudden changes in the rotational direction or speed of the rotatable brush. Accordingly, previous turf sweepers were subject to damage or safety concerns due to sudden changes in rotational direction and speed.

### SUMMARY OF THE INVENTION

In part, the present application relates to a process for operating a turf sweeper. In one embodiment, the process includes monitoring the setting of a brush speed adjuster having a maximum setting that causes the rotatable brush to rotate at a maximum speed, a zero setting that causes no rotational speed of the rotatable brush and at least one intermediate setting that cause the rotatable brush to rotate at an intermediate speed. The process further includes preventing the rotatable brush from rotating if the brush speed adjuster is not set to the zero setting when the turf sweeper is turned on. The process further includes causing the rotatable brush to rotate if the brush speed adjuster is set to the zero position at or after the time when the turf sweeper is turned on and the brush speed adjuster is subsequently adjusted to the maximum setting or the intermediate setting.

In another aspect, the process includes monitoring the setting of a directional adjuster having a forward setting that causes forward rotation of the rotatable brush and a reverse setting that causes reverse rotation of the rotatable brush.

In a still further aspect, the process includes determining the setting of the brush speed adjuster when the setting of the directional adjuster is changed.

In a yet further aspect, the process includes preventing the rotatable brush from changing the direction of its rotation in response to a change in the setting of the directional adjuster if the brush speed adjuster is not set to the zero setting.

In an even further aspect, the process includes causing the rotatable brush to change the direction of its rotation in response to a change in the setting of the direction adjuster if the brush speed adjuster is set to the zero setting at or after the time at which the direction adjuster changes setting and the brush speed adjuster is subsequently adjusted to the maximum setting or the one intermediate setting.

In another aspect, the process includes monitoring the setting of the speed adjuster and the directional adjuster using voltage or current signals.

In a different aspect, the process includes controlling a proportional control valve in response to communications from the speed adjuster such that when the speed adjuster is set to the maximum setting a maximum flow of hydraulic fluid is delivered to the hydraulic motor, when the speed adjuster is set to the zero setting no hydraulic fluid is delivered to the hydraulic motor and when the speed adjuster is set to the intermediate setting, an intermediate flow is delivered to the hydraulic motor.

In a still even further aspect, the process includes controlling a directional control valve in response to communications from the directional adjuster such that the hydraulic motor causes forward rotation of the rotatable brush when the directional adjuster is in the forward setting and such that the hydraulic motor causes reverse rotation of the rotatable brush when the directional adjuster is in the reverse setting.

In a yet another further aspect, the process includes delaying the change in speed of the rotatable brush in response to a change in the setting of the brush speed adjuster.

In a further embodiment, the present application relates to a turf sweeper system. The system includes a hydraulic motor configured to rotate in a first direction and a second direction and further configured to receive different volume flow rates of hydraulic fluid. The system further includes a rotatable brush wherein the rotatable brush is operationally connected to the hydraulic motor such that the hydraulic motor imparts rotational speed and direction to the rotatable brush. The system further includes a hydraulic integrated circuit comprising a directional control valve, a proportional control valve and passages within the hydraulic integrated circuit wherein the hydraulic integrated circuit is in fluid communication with the hydraulic motor and wherein the directional control valve is attached to the hydraulic integrated circuit and controls the direction in which the hydraulic motor rotates by directing the flow of hydraulic fluid through the passages in the hydraulic integrated circuit. Further, the proportional control valve can be attached to the hydraulic circuit and controls the volume flow rate of hydraulic fluid to the hydraulic motor. The system further includes a directional adjuster having a forward setting and a reverse setting. The system further includes a brush speed adjuster having a zero setting, a maximum setting and at least one intermediate setting.

In an even further aspect of the system, the system includes a controller wherein the controller is in communication with the directional adjuster, the brush speed adjuster, the proportional control valve and the directional control valve, monitors the setting of the directional adjuster and the brush speed adjuster and causes the proportional control valve to adjust in response to adjustment of the brush speed adjuster. The controller further causes the directional control valve to adjust in response to adjustment of the directional adjuster. The controller further prevents the directional control valve from directing hydraulic fluid to the hydraulic motor if the brush speed adjuster is not set to the zero setting when the turf sweeper is turned on and causes the directional control valve to direct hydraulic fluid to the hydraulic motor if the brush speed adjuster is set to the zero position at or after the time when the turf sweeper is turned on and the brush speed adjuster is subsequently adjusted to the maximum position or at least one intermediate position.

In a still further aspect of the system, the controller determines whether the brush speed adjuster is in the zero setting when the setting of the directional adjuster is changed.

In a still even further aspect of the system, the controller will not cause the directional control valve to adjust such that the rotatable brush changes rotational direction if the brush speed adjuster is not in the zero setting.

In a yet even further aspect of the system, when the setting of the directional adjuster is changed and the brush speed adjuster is in the zero setting the controller will cause the directional control valve to adjust positions such that the flow of hydraulic fluid to the hydraulic motor will change direction.

In a different further aspect of the system, the controller communicates with the proportional control valve and directional control valve through a voltage or current signal and the directional adjuster and brush speed adjuster communicate with the controller through a voltage or current signal.

In another further aspect of the system, the controller delays adjusting the proportional control valve in response to a change in the setting of the brush speed adjuster.

In a further aspect of the system, the hydraulic integrated circuit further comprises a first motor port, a second motor port, a fluid input port and a fluid output port wherein the fluid input and fluid output ports are in communication with a hydraulic fluid storage tank and the first motor port and second motor port are in fluid communication with the hydraulic motor.

In a still further aspect of the system, the directional adjuster can be set to a first setting or a second setting and when the directional adjuster is in the first setting, the controller causes the directional control valve to cause hydraulic fluid to flow out of the first motor port to the hydraulic motor and into the second motor port causing the hydraulic motor to rotate in a forward direction and when the directional adjuster is in the second setting, the controller causes the directional control valve to cause hydraulic fluid to flow out of the second motor port to the hydraulic motor and into the first motor port causing the hydraulic motor to rotate in a reverse setting.

In another further aspect of the system, the brush speed adjuster is set to the zero setting, the controller causes the proportional control valve to adjust such that no hydraulic fluid reaches the hydraulic motor and when the brush speed adjuster is set to the maximum setting, the controller causes the proportional control valve to be fully opened.

### BRIEF DESCRIPTION OF THE DRAWINGS

FIG. 1 is an illustration of one embodiment of a turf sweeper utilizing the described hydraulic control system.

FIG. 2 is an illustration of one embodiment of the dashboard of a turf sweeper utilizing the described hydraulic control system.

FIG. 3 is a schematic illustration of the hydraulic components of a turf sweeper utilizing an embodiment of the described hydraulic control system.

FIG. 4 is a perspective illustration of a hydraulic integrated circuit for use with an embodiment of the described hydraulic control system. The internal passages of the hydraulic integrated circuit are not shown in FIG. 4.

FIG. 5 is a hydraulic circuit diagram depicting an embodiment of the described hydraulic control system and the flow passages therein.

FIG. 6 is a flow chart diagram illustrating an embodiment of a method for using a hydraulic circuit for use with a turf sweeper.

### DETAILED DESCRIPTION OF SELECT EMBODIMENTS

In the description that follows, like parts are marked throughout the specification and drawings with the same reference numerals, respectively. The drawings are not necessarily to scale and the proportions of certain parts have been exaggerated to better illustrate details and features of the invention. Where components of relatively well-known designs are employed, their structure and operation will not be described in detail.

The current disclosure is directed to a hydraulic control system utilizing a hydraulic integrated circuit (HIC) for variable control of the speed and direction of a hydraulic motor. For example, the system of this disclosure can be useful to control the brush of a turf sweeper.

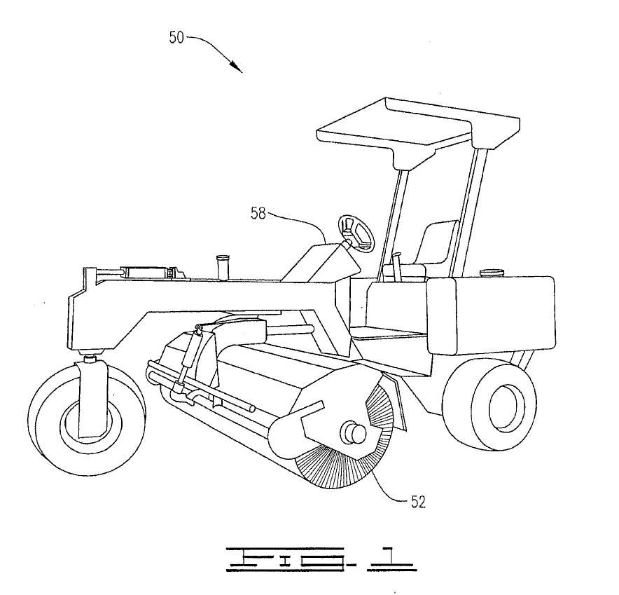

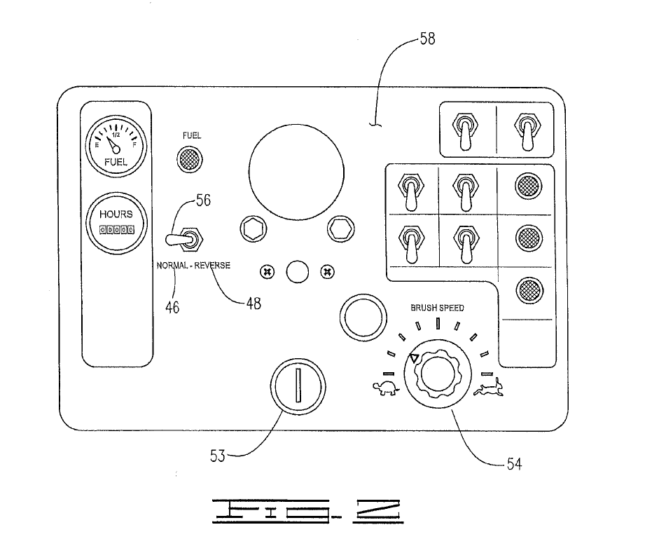

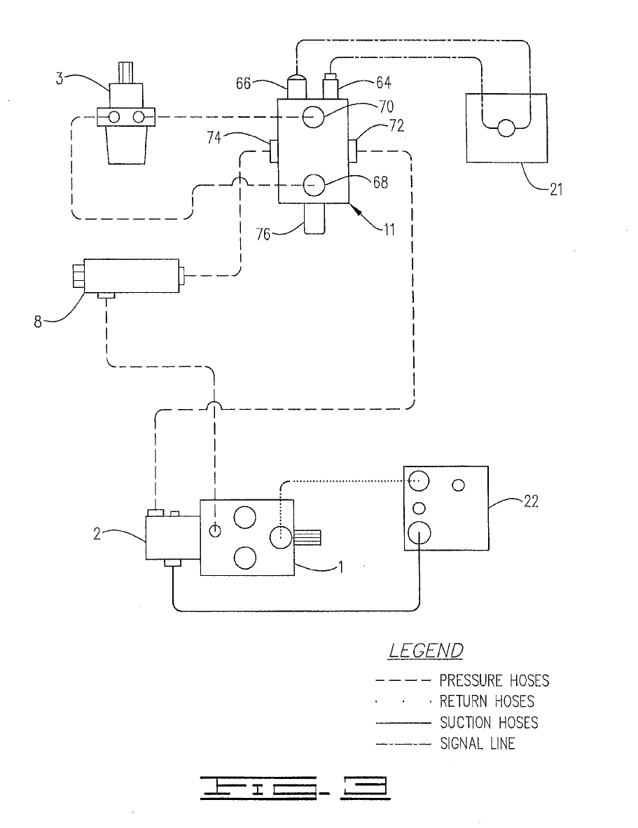

FIG. 1 shows a turf sweeper 50 in which the present hydraulic system can be used. Turf sweeper 50 comprises a rotatable brush 52. Typically, a hydraulic motor 3 (FIG. 3) causes the rotatable brush to rotate at a desired speed. The hydraulic motor is controlled by HIC 11 and controller 21 (FIG. 3). The operator of the turf sweeper can control the operation of the rotatable brush 52 through the brush speed adjuster 54 and directional adjuster 56 (FIG. 2), which can be located on a control dashboard 58.

Referring to FIG. 2, control dashboard 58 is illustrated. As mentioned above, speed adjuster 54 and directional adjuster 56 are typically located on dashboard 58. Speed adjuster 54 interacts with HIC 11 and controller 21 to adjust the rotational speed of rotatable brush 52. The speed adjuster 54 and directional adjuster 56 can interact with the controller 21 and HIC 11 in any suitable manner. For example, the speed adjuster 54 and directional adjuster 56 can communicate with the controller 21 via electrical signals. Further, speed adjuster 54 can be any suitable variable speed hand controller.

The speed adjuster 54 will typically have a number of different settings at which the speed adjuster 54 can be set. For example, the speed adjuster 54 can have a zero setting, which will cause no rotatable brush 52 rotation. Additionally, the speed adjuster 54 can have a maximum setting, which will cause the rotatable brush 52 to rotate at a maximum speed. Further, the speed adjuster 54 can have any number of a plurality of intermediate settings between the zero setting and the maximum setting that will cause the rotatable brush 52 to rotate at any number of speeds between no brush rotation and the rotatable brush rotating at a maximum speed. Stated another way, the brush speed adjuster 54 has at least one intermediate setting between the zero setting and the maximum setting.

For example, in one embodiment the speed adjuster 54 can be a potentiometer. If the speed adjuster comprises a potentiometer, the speed adjuster can send a series of graduated signals with a lowest signal of zero, corresponding to no brush rotation. Similarly, the potentiometer can send a predetermined maximum signal, corresponding to a maximum brush rotational speed. Additionally, the potentiometer can send a continuous series of intermediate signals between zero and the maximum brush rotation, which corresponds to a continuous series of intermediate brush rotational speeds.

Directional adjuster 56 generally has a first setting or forward setting 46 corresponding to forward rotation of rotatable brush 52 and a second setting or reverse setting 48 corresponding to reverse rotation of rotatable brush 52. As the above description and FIG. 2 make clear, the speed adjuster 54 and directional adjuster 56 may take any appropriate form. For example, the speed and directional adjuster may be in the form of a knob and a switch or may be in the form of a digital control system.

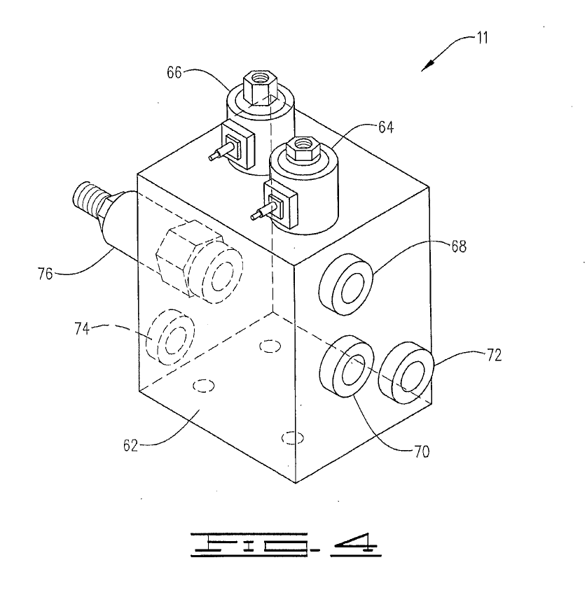

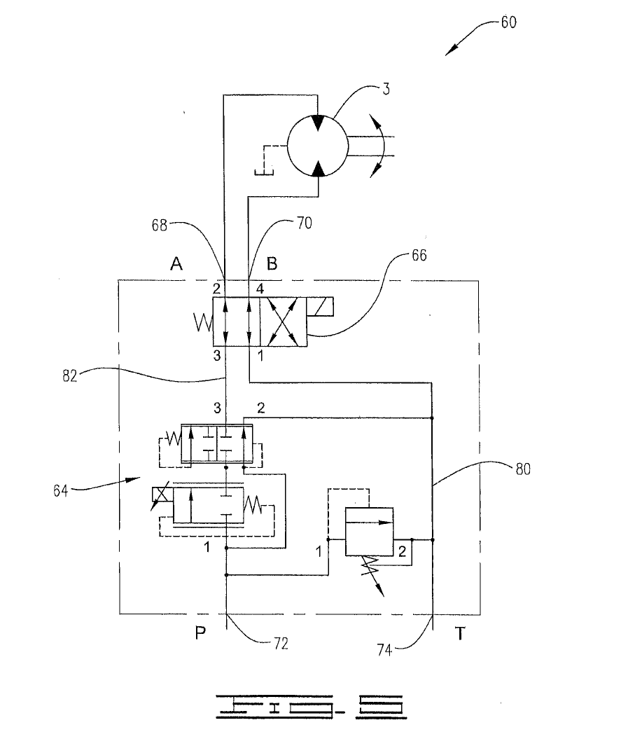

Referring to FIGS. 3, 4 and 5, HIC 11 and controller 21 are further explained. FIG. 3 is a schematic illustration of the hydraulic components of a turf sweeper in accordance with one embodiment of the current system. FIG. 4 is a perspective illustration of HIC 11. FIG. 5 is a hydraulic circuit diagram illustrating the components and flow within HIC 11. The ports in HIC 11 have been illustrated with different placements among the figures for ease of illustration.

As shown in FIG. 5, HIC 11 has flow passages for the hydraulic fluid. Proportional control valve 64 and directional control valve 66 are operationally attached to HIC 11 such that they direct the flow speed and direction of the hydraulic fluid flow through the flow passages in HIC 11. Proportional control valve 64 and directional control valve 66 are also operationally connected to brush speed adjuster 54 and directional adjuster 56, respectively, so that adjustment of the flow speed and direction can be made from dashboard 58. Also, controller 21 is operationally connected to proportional control valve 64 and directional control valve 66 so as to functionally control the operation of HIC 11, as further described below. Controller 21 can be any suitable controller. Examples of suitable controllers are sold by Danfoss under the designations MC012-010 and MC012-012 controllers.

As best seen from FIG. 3, HIC 11 further has first motor port 68, second motor port 70, fluid input port 72 and fluid output port 74. First motor port 68 and second motor port 70 are in fluid flow communication with and provide hydraulic fluid to run hydraulic motor 3, which drives rotatable brush 52. Fluid input port 72 receives hydraulic fluid from tank 22 via gear pump 2. Hydraulic fluid is returned to the tank 22 via fluid output port 74. The returning hydraulic fluid can be sent through high pressure filter 8 and then returned to tank 22 via variable pump 1, as illustrated. Additionally, relief valve 76 is operationally connected to HIC 11 to allow for hydraulic fluid pressure release.

As can best be seen from FIG. 5, flow of hydraulic fluid entering through fluid input port 72 is controlled by proportional control valve 64, which can be a normally closed spool type proportional flow control valve. An example of a suitable proportional control valve is sold by Comatrol under the designation PFC12-RC.

Proportional control valve 64 is controlled by brush speed adjuster 54. When brush speed adjuster 54 is at zero, it sends no signal to proportional control valve 64, which results in proportional control valve 64 being in the closed mode; thus, a volume of hydraulic fluid flows through flow passage 80 to fluid output port 74 to return to tank 22. Stated another way, a volume flow rate of hydraulic fluid flows through the flow passage 80 to fluid output port 74 to return to tank 22. As brush speed adjuster 54 is turned from zero, it sends a signal, which changes proportional control valve 64 to the open setting to allow a volume of fluid flow along flow passage 82. Further turning the knob increases the signal from brush speed adjuster 54 and results in proportional control valve 64 increasing the volume flow rate of hydraulic fluid along flow passage 82.

Flow from passage 82 out through first motor port 68 and second motor port 70 to hydraulic motor 3 is controlled by directional control valve 66, which can be a four way, two setting valve, such as a solenoid valve. An example of a suitable directional control valve is sold by Comatrol under the designation sv15-24-01.

Directional control valve 66 is controlled by directional adjuster 56 each having corresponding first settings and second settings. When directional adjuster 56 is in first setting 46, directional control valve 66 is placed in its first setting and allows hydraulic fluid flow out first motor port 68 to hydraulic motor 3 and into second motor port 70, which is referred to herein as the forward direction. When directional adjuster 56 is in second setting 48, directional control valve 66 is placed in its second setting and allows hydraulic fluid flow out from second motor port 70 to hydraulic motor 3 and into first motor port 68, which is referred to herein as the reverse direction. Hydraulic motor 3 is a duel direction, variable speed, hydraulic motor; thus, the direction of flow determines the direction that hydraulic motor 3 turns rotatable brush 52 and the flow rate of hydraulic fluid determines the speed of rotation for rotatable brush 52.

In operation, rotatable brush 52 is turned when an adequate supply of hydraulic fluid, such as oil, is supplied to hydraulic motor 3, which is operationally connected to rotatable brush 52. The hydraulic fluid supply is provided to HIC 11 and then to hydraulic motor 3 from tank 22 by a hydraulic gear pump 2. HIC 11 controls the volume and flow path to hydraulic motor 3. Controller 21, through a program, provides as signal, generally a voltage or current signal, to proportional control valve 64 and directional control valve 66 of HIC 11 thereby controlling the flow to hydraulic motor 3 based on the settings of directional adjuster 56 and brush speed adjuster 54. By controlling the flow to hydraulic motor 3, controller 21 thus controls the direction and speed of rotatable brush 52.

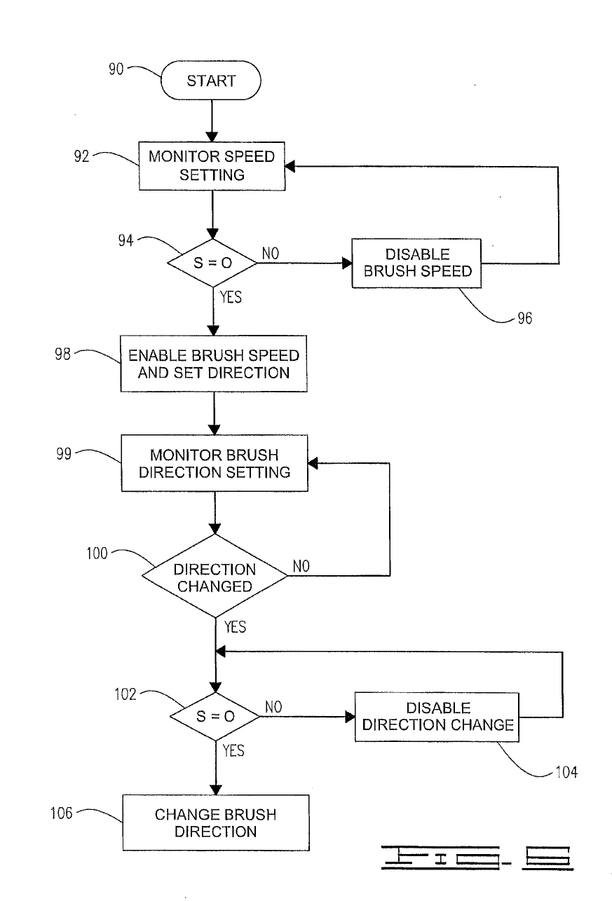

Turning now to FIG. 6, the operation of the system will be further explained focusing on controller 21. In step 90, the key switch 53 of turf sweeper 50 is turned on and the engine is started, thus supplying power to controller 21. In accordance with step 92, the controller 21 is programmed to start monitoring the input of brush speed adjuster 54. In step 94, controller 21 determines if brush speed adjuster 54 is set to zero. If brush speed adjuster 54 is not in the zero setting at startup, controller 21 disables brush speed. In other words, the controller will position the directional control valve to prevent the flow of hydraulic fluid to hydraulic motor 3, thereby preventing rotatable brush 52 from turning (step 96). Thus, abrupt starts of rotatable brush 52, which can create safety concerns and cause wear on the turf sweeper system components, are avoided.

If brush speed adjuster 54 is set to zero at start up or once it is thereafter turned to zero, controller 21 enables the adjustment of the brush speed in step 98. That is, rotation of rotatable brush 52 can be started by turning brush speed adjuster 54 to zero and then to the desired rate of rotation. At this time, the proportional control valve 64, through controller 21, is supplied enough current to achieve the flow rate necessary to turn rotatable brush 52 at the desired speed set by brush speed adjuster 54. For example, if brush speed adjuster 54 is a potentiometer, brush speed adjuster 54 can provide a voltage signal from 0 to 2 volts of DC current, which would correspond to zero rotation of rotatable brush at 0 volts (i.e. no rotational power supplied by hydraulic motor 3) up to full rotation at 2 volts (i.e. maximum rotational power supplied by hydraulic motor 3).

The signal from brush speed adjuster 54 is regulated by controller 21 in order to provide for a controlled rotational speed ramp. Stated another way, the controller 21 causes a “delay in the change of speed” which means any change in brush speed is spread out over a sufficient time to avoid potential damage to the components of the turf sweeper or danger to any operators. For example, if the brush speed adjuster 54 is set to a speed close to the zero position and is adjusted to the maximum position, the controller will not cause the proportional control valve 64 to adjust to a position causing a maximum flow of hydraulic fluid to the hydraulic motor 3 as quickly as the system is capable. That is, the controller will cause the proportional control valve 64 to adjust over an extended period of time such that the flow of hydraulic fluid to the hydraulic motor 3 is spread over a period of time deemed sufficiently safe. In the above example, the controller 21 might cause the proportional control valve to adjust to a position allowing a maximum flow of hydraulic fluid to the hydraulic motor over a period of 3 seconds. Without the intervention of the controller, the proportional control valve would adjust to a position allowing a maximum flow of hydraulic fluid to the hydraulic motor in a much shorter period, such as less than a second. The actual predetermined ramp period may be more or less but, generally, will be from about 1 second to about 7 seconds and, more typically, from about 2 seconds to about 5 seconds.

Controller 21 continues to monitor brush speed adjuster 54 and directional adjuster 56 (step 100). Controller 21 handles speed adjustments or movements of brush speed adjuster 54 as described above. Additionally, controller 21 monitors directional adjuster (step 99) to determine if the directional adjuster 56 is changed between its reverse and forward settings (step 100). When a directional change is detected, controller 21 determines if brush speed adjuster 54 is set to zero (step 102). If brush speed adjuster 54 is not in the zero setting at the time the setting of directional adjuster 56 is changed, controller 21 disables the direction change or, in other words, keeps hydraulic fluid to hydraulic motor 3 flowing in the same direction, so rotatable brush 52 does not switch between reverse and forward rotation (step 104). Thus, abrupt direction changes of the rotation of rotatable brush 52 are avoided. Such abrupt direction changes can create safety concerns and cause wear on the turf sweeper system components, such as the hydraulic motor shaft.

If brush speed adjuster 54 is set to the zero setting at the time the setting of directional adjuster 56 is changed, or once it is thereafter turned to zero, controller 21 enables the rotational direction change of rotatable brush 52 (step 106). That is, once brush speed adjuster 54 is moved to the zero setting and then rotated to increase power, the direction of rotation for rotatable brush 52 will be the new direction.

Optionally, controller 11 further monitors the position of the brush speed adjuster 54 and directional adjuster 56. If the directional adjuster 56 setting is changed and the brush speed adjuster 54 is not set to the zero position, the controller 11 can cause the rotatable brush 52 to stop rotating. In one embodiment, the controller causes the rotatable brush 52 to stop rotating by causing the proportional control valve 64 to cause no hydraulic fluid to flow to the hydraulic motor 3. If the brush speed adjuster 56 is set to the zero position when the directional adjuster 56 setting is adjusted, subsequent adjustment of the brush speed adjuster to a setting other than the zero setting will cause the rotatable brush 52 to rotate at the desired speed and direction. Further, if the brush speed adjuster 56 is not set to the zero position when the directional adjuster 56 setting is adjusted, but the brush speed adjuster 56 is subsequently adjusted to the zero position, then, after adjustment to the zero position, further adjustment of the brush speed adjuster 56 will cause the rotatable brush 52 to rotate in the specified direction.

In addition to having a separate brush speed adjuster 54 and directional adjuster 56, both adjusters can also be combined into a single adjuster that controls both the rotational direction and speed of the rotatable brush 52. For example, such a combined adjuster might allow for a plurality of settings between two extremes. On one extreme might be a setting causing maximum rotational speed in a first or forward direction. On another extreme might be a setting causing maximum rotational speed in a second or reverse direction. Between the two extremes would be a zero setting which caused no rotational speed of the rotatable brush 52. Between the zero setting and the setting causing a maximum rotational speed in a first direction would be at least one intermediate speed setting that caused the rotatable brush to rotate at an intermediate speed in the first direction. Between the zero setting and the setting causing maximum rotational speed in a second directional would be at least one intermediate speed that caused the rotatable brush to rotate at an intermediate speed in the second direction. More than one intermediate speed setting could also be employed in either direction.

Although the invention has been described with reference to a specific embodiment, the foregoing description is not intended to be construed in a limiting sense. Various modifications as well as alternative applications will be suggested to persons skilled in the art by the foregoing specification and illustrations. It is therefore contemplated that the appended claims will cover any such modifications, applications or embodiments as followed in the true scope of this invention.

What is claimed is:

1. A process for operating a turf sweeper having a rotatable brush comprising:
(a.) monitoring a brush speed adjuster having a maximum setting that causes the rotatable brush to rotate at a maximum speed, a zero setting that causes no rotational speed of the rotatable brush, and at least one intermediate settings that cause the rotatable brush to rotate at an intermediate speed to determine the setting of the brush speed adjuster;
(b.) preventing the rotatable brush from rotating if the brush speed adjuster is not set to the zero setting when the turf sweeper is turned on; and
(c.) causing the rotatable brush to rotate if the brush speed adjuster is set to the zero position at or after the time when the turf sweeper is turned on and the brush speed adjuster is subsequently adjusted to the maximum setting or the intermediate setting.

2. The process of claim 1 further comprising monitoring a directional adjuster having a forward setting that causes forward rotation of the rotatable brush and a reverse setting that causes reverse rotation of the rotatable brush to determine the setting of the directional adjuster.

3. The process of claim 2 further comprising determining the setting of the brush speed adjuster when the setting of the directional adjuster is changed.

4. The process of claim 3 further comprising preventing the rotatable brush from changing the direction of its rotation in response to a change in the setting of the directional adjuster if the brush speed adjuster is not set to the zero setting.

5. The process of claim 4 further comprising causing the rotatable brush to change the direction of its rotation in response to a change in the setting of the direction adjuster if the brush speed adjuster is set to the zero setting at or after the time at which the direction adjuster changes setting and the brush speed adjuster is subsequently adjusted to the maximum setting or the intermediate setting.

6. The process of claim 5 further comprising monitoring the setting of the speed adjuster and the directional adjuster using voltage or current signals.

7. The process of claim 6 further comprising controlling a proportional control valve in response to communications from the speed adjuster such that when the speed adjuster is set to the maximum setting a maximum flow of hydraulic fluid is delivered to the hydraulic motor, when the speed adjuster is set to the zero setting no hydraulic fluid is delivered to the hydraulic motor and when the speed adjuster is set to the intermediate setting, an intermediate flow is delivered to the hydraulic motor.

8. The process of claim 7 further comprising controlling a directional control valve in response to communications from the directional adjuster such that the hydraulic motor causes forward rotation of the rotatable brush when the directional adjuster is in the forward setting and such that the hydraulic motor causes reverse rotation of the rotatable brush when the directional adjuster is in the reverse setting.

9. The process of claim 8 further comprising delaying the change in speed of the rotatable brush in response to a change in the setting of the brush speed adjuster.

10. A turf sweeper comprising:
a hydraulic motor configured to rotate in a first direction and a second direction and further configured to receive different volume flow rates of hydraulic fluid;
a rotatable brush wherein the rotatable brush is operationally connected to the hydraulic motor such that the hydraulic motor imparts rotational speed and direction to the rotatable brush;
a hydraulic integrated circuit comprising a directional control valve, a proportional control valve and passages within the hydraulic integrated circuit;
wherein the hydraulic integrated circuit is in fluid communication with the hydraulic motor;
wherein the directional control valve is attached to the hydraulic integrated circuit and controls the direction in which the hydraulic motor rotates by directing the flow of hydraulic fluid through the passages in the hydraulic integrated circuit; and
wherein the proportional control valve is attached to the hydraulic integrated circuit and controls the volume flow rate of hydraulic fluid to the hydraulic motor;
a directional adjuster having a forward setting and a reverse setting;
a brush speed adjuster having a zero setting, a maximum setting and at least one intermediate setting;
a controller wherein;
i. the controller is in communication with the directional adjuster, the brush speed adjuster, the proportional control valve and the directional control valve;
ii. the controller monitors the setting of the directional adjuster and the brush speed adjuster and causes the proportional control valve to adjust in response to adjustment of the brush speed adjuster and causes the directional control valve to adjust in response to adjustment of the directional adjuster;
iii. the controller prevents the directional control valve from directing hydraulic fluid to the hydraulic motor if the brush speed adjuster is not set to the zero setting when the turf sweeper is turned on;
iv. the controller causes the directional control valve to direct hydraulic fluid to the hydraulic motor if the brush speed adjuster is set to the zero position at or after the time when the turf sweeper is turned on and the brush speed adjuster is subsequently adjusted to the maximum position or at least one intermediate position.

11. The turf sweeper of claim 10, wherein the controller determines whether the brush speed adjuster is in the zero setting when the setting of the directional adjuster is changed.

12. The turf sweeper of claim 11, wherein the controller will not cause the directional control valve to adjust such that the rotatable brush changes rotational direction if the brush speed adjuster is not in the zero setting.

13. The turf sweeper of claim 12, wherein when the setting of the directional adjuster is changed and the brush speed adjuster is in the zero setting the controller will cause the directional control valve to adjust positions such that the flow of hydraulic fluid to the hydraulic motor will change direction.

14. The turf sweeper of claim 13, wherein the controller communicates with the proportional control valve and directional control valve through a voltage or current signal and the directional adjuster and brush speed adjuster communicate with the controller through a voltage or current signal.

15. The turf sweeper of claim 14, wherein the controller delays adjusting the proportional control valve in response to a change in the setting of the brush speed adjuster.

16. The turf sweeper of claim 15, wherein the hydraulic integrated circuit further comprises a first motor port, a second motor port, a fluid input port and a fluid output port wherein the fluid input and fluid output ports are in communication with a hydraulic fluid storage tank and the first motor port and second motor port are in fluid communication with the hydraulic motor.

17. The turf sweeper of claim 16 wherein the directional adjuster can be set to a first setting or a second setting and when the directional adjuster is in the first setting, the controller causes the directional control valve to cause hydraulic fluid to flow out of the first motor port to the hydraulic motor and into the second motor port causing the hydraulic motor to rotate in a forward direction and when the directional adjuster is in the second setting, the controller causes the directional control valve to cause hydraulic fluid to flow out of the second motor port to the hydraulic motor and into the first motor port causing the hydraulic motor to rotate in a reverse setting.

18. The turf sweeper of claim 17, wherein when the brush speed adjuster is set to the zero setting, the controller causes the proportional control valve to adjust such that no hydraulic fluid reaches the hydraulic motor and when the brush speed adjuster is set to the maximum setting, the controller causes the proportional control valve to be fully opened.
